(19) United States
(12) Patent Application Publication
(10) Pub. No.: US 2013/0110905 A1
(43) Pub. Date: May 2, 2013

(54) FILE TYPE ASSOCIATIONS FOR REMOTE APPLICATIONS

(71) Applicants: Travis M. Howe, Bellevue, WA (US); Naga Venkata Rajagopal Ramadugu, Hyderabad (IN); Yuvraj Budhraja, Redmond, WA (US); Kevin S. London, Monroe, WA (US); Ido M. Ben-Shachar, Kirkland, WA (US)

(72) Inventors: Travis M. Howe, Bellevue, WA (US); Naga Venkata Rajagopal Ramadugu, Hyderabad (IN); Yuvraj Budhraja, Redmond, WA (US); Kevin S. London, Monroe, WA (US); Ido M. Ben-Shachar, Kirkland, WA (US)

(73) Assignee: MICROSOFT CORPORATION, Redmond, WA (US)

(21) Appl. No.: 13/283,641

(22) Filed: Oct. 28, 2011

(51) Int. Cl. G06F 15/16

(52) U.S. Cl. 709/203

(57) ABSTRACT

Embodiments are directed to publishing file type associations for remote applications and to automatically updating file type associations for remote applications. In an embodiment, a remote application server sends to an administrative user an indication of remote applications that are provided by the remote application server. The remote application server of receives from the administrative user an indication of those remote applications that are to be published for computer systems managed by the administrative user. The remote application server also receives from the administrative user an indication of which file type associations are to be published for the indicated remote applications and publishes the indicated remote applications with the indicated file type associations on the remote application server. In this manner, users accessing the remote application server have access to the published applications with the remote applications' associated file types.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications are provided by remote computer systems. For instance, instead of remotely providing an entire client desktop (e.g. on a thin client machine), a single software application may be provided by a remote server. This remote application may act as though it is installed locally, but will be provided by and run on the remote server. The remote server may be configured to provide various different types of software applications. Each of these applications may have associated file types. These associated file types link certain types of files to that application. For instance, file type associations may link hypertext markup language (HTML) files with a certain web browser. Then, when a user opens an HTML file, that browser will be used to open the file. Maintaining proper file type associations with applications on the remote server may be difficult.

### BRIEF SUMMARY

Embodiments described herein are directed to publishing file type associations for remote applications and to automatically updating file type associations for remote applications. In one embodiment, a remote application server sends to an administrative user an indication of remote applications that are provided by the remote application server. The remote application server receives from the administrative user an indication of those remote applications that are to be published for computer systems managed by the administrative user. The remote application server also receives from the administrative user an indication of which file type associations are to be published for the indicated remote applications and publishes the indicated remote applications with the indicated file type associations on the remote application server. In this manner, users accessing the remote application server have access to the published applications with the remote applications' associated file types.

In another embodiment, a local client computer system receives feed data from a remote application server. The local client computer system includes local file type associations for various locally installed software applications. The local client computer system then accesses the received feed data. The feed data indicates which remote applications are provided by the remote application server. The feed data also indicates various different file type associations for each of the remote applications provided by the remote application server. The local client computer system then automatically updates the local file type associations with the received file type associations for the remote software applications. As such, the client computer system's file type associations include at least one local application and at least one remote application.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments of the invention may be realized and obtained by means of the instruments and combinations particularly pointed out in the appended claims. Features of the embodiments of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The embodiments of the invention will be described and explained with additional specificity and detail through the use of the accompanying drawings in which:

FIG. 1 illustrates a computer architecture in which embodiments of the present invention may operate including publishing file type associations for remote applications and automatically updating file type associations for remote applications.

FIG. 2 illustrates a flowchart of an example method for publishing file type associations for remote applications.

FIG. 3 illustrates a flowchart of an example method for automatically updating file type associations for remote applications.

FIG. 4 illustrates a computing environment in which file type associations are automatically updated for remote applications.

### DETAILED DESCRIPTION

Embodiments described herein are directed to publishing file type associations for remote applications and to automatically updating file type associations for remote applications. In one embodiment, a remote application server sends to an administrative user an indication of remote applications that are provided by the remote application server. The remote application server receives from the administrative user an indication of those remote applications that are to be published for computer systems managed by the administrative user. The remote application server also receives from the administrative user an indication of which file type associations are to be published for the indicated remote applications and publishes the indicated remote applications with the indicated file type associations on the remote application server. In this manner, users accessing the remote application server have access to the published applications with the remote applications' associated file types.

In another embodiment, a local client computer system receives feed data from a remote application server. The local client computer system includes local file type associations for various locally installed software applications. The local client computer system then accesses the received feed data. The feed data indicates which remote applications are provided by the remote application server. The feed data also indicates various different file type associations for each of the remote applications provided by the remote application server. The local client computer system then automatically updates the local file type associations with the received file type associations for the remote software applications. As such, the client computer system's file type associations include at least one local application and at least one remote application.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmissions media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

Initially, some terminology will be defined. The following terms are defined below and are used in that context throughout. A “file type association” (FTA) refers to an association between a file type (e.g. “.txt”) and an application (e.g. “Notepad”). The ramifications of this association depends on the kind of file type association (see below). A “secondary handler file type association” refers to a file type association in which the application is capable of opening files of that type, but it is not the main program for handling files of that type. For example: Microsoft®Word is capable of opening “.html” files, but it is usually not the main handler for those types of files. Typically a web browser is the application associated with that file type. Thus, in this example, Microsoft® Word may be a secondary handler for “.html” files.

Some ramifications of being a secondary handler may include the following: the program will be listed in the “Open With” list for files of that type. If the primary handler is uninstalled, one of the secondary handlers may potentially be promoted to primary handler by the operating system. There can be substantially any number of secondary handlers for a given file type.

A “primary handler file type association” refers to a file type association that declares that the application should be the main program for opening files of that type. For example: Microsoft® Word may install itself as a primary handler for “.doc” files. Some ramifications of being a primary handler may include the following: in the operating system, when a user double-clicks a file of that type, they may be shown the list of primary handlers and asked to choose which one they'd like to use. Their choice becomes the “user choice handler” for that file type (see below). Moreover, being a primary handler includes all the ramifications of a secondary handler.

A “user choice handler” indicates, for a given file type, the application that the user has chosen to open files of that type. A “per-machine file type association” refers to a file type association that applies to all users on a specific machine. Both primary and secondary handler file type associations can be specified at a per-machine level. In some embodiments, there can be at most one per-machine primary handler file type association for any given file type. A “per-user file type association” refers to a file type association that applies only to a specific user. Both primary and secondary handler file type associations can be specified at the per-user level.

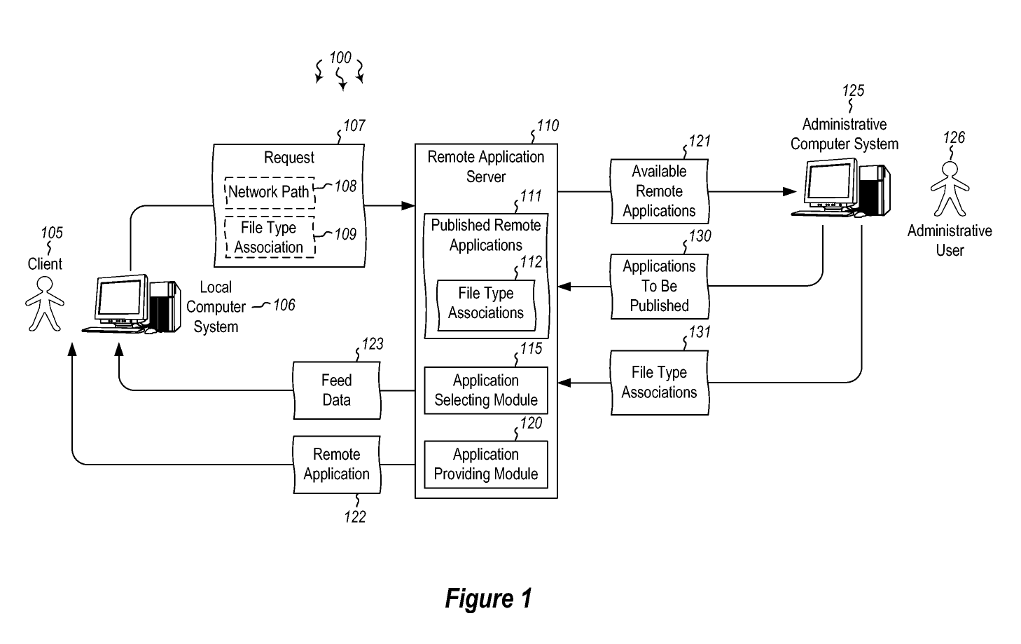

Using various application management tools, administrators may be able to publish a collection of remote applications in a “workspace”. This includes the name & icon for the application, and all the information required to make a remote connection to a machine and launch the application on the remote machine. Embodiments described herein allow administrators (e.g. 126 of FIG. 1), when they are publishing remote applications 111, to also publish a set of file types 131 that should be associated with those remote applications. The set of file types that are available to be published for any given application is determined by scanning the current per-machine (i.e. per-computer-system) file type associations on a machine sufficiently similar to the endpoint machine that end-users 105 will ultimately be connecting to (e.g. remote application server 110). The administrator can choose which file types they would like to publish associations for, and how those file type associations should be installed on the client machine (e.g. as primary handler or secondary handler). Once the administrator has made his or her decision, the list of published applications and file types is serialized into feed data 123 (e.g. into an extensible markup language (XML) feed).

Clients subscribe to the XML feed that contains the list of published remote applications and file types. When a client software application gets a new version of the XML feed, the client application reads in the list of remote applications and file types. For each published remote application, the client application then registers the remote application for each published file type as a per-user file type association in the way that was specified by the administrator (i.e. primary handler or secondary handler).

When an end-user triggers a remote app file type association (e.g. double-clicks a file on their client machine whose type is associated with a remote application), a request 107 is sent to the remote application server 110 to make the connection to the requested file. As part of that request, a network path 108 for the remote application that should be used to open the file can also be sent. If that remote application is allowed to be opened on the server, the remote application server is instructed to open that file using the network path for the specified application.

Alternatively, implementers can choose not to send a network path (or other identifier) for the remote application that should be used to open the file, and just send the information for the file that should be opened. In this case, the remote application server code can check what the current per-machine primary handler is for that file's type. If that application is allowed, the remote application server is instructed to open that file using the current per-machine primary handler for its file type.

Embodiments described herein include one or more of the following aspects: 1) the ability to mirror a server's per-machine file type associations (both primary handler and secondary handler) on a client machine as per-user primary file type associations. 2) the ability to provide a list of published file type associations from server to client (where the client is either a managed corporate personal computer or a user's personal home machine) via an XML feed. 3) the ability to restrict how remote application file type associations are executed on the server using the application published by the administrator, and not the current user choice handler on the server. (Or, alternatively, the ability to restrict how remote application file type associations are executed on the server using the per-machine primary handler on the server, not the current user choice handler on the server.) 4) the ability to display file type associations for remote applications in the operating system UI with the correct icon and application name for the remote application. 5) the ability for an administrator to choose which of the server's per-machine file type associations are to be mirrored to clients, and whether they are to be installed as primary handler or secondary handler file type associations on the client.

Various different components may be used in the embodiments described herein. These components may include any one or more of the following: 1) an administrator UI that communicates with the settings reader on the remote application server 110 to determine the list of remote applications available to be published, and for each of those applications, the list of file type associations available to be published. The administrator UI also allows the administrator to select which applications are to be published on the remote application server, and for those applications, which file type associations are to be published. The administrator UI also writes the list of published applications and file type associations to the a publishing endpoint on the remote application server(s) and (optionally) to a web server.

2) A remote application server which the end-user will ultimately connect to. The remote application server may have a settings reader that reads the per-machine file type associations from the system registry. The publishing endpoint accepts the published applications and FTAs and writes them to a publishing data storage. 3) A connection endpoint may be configured to handle incoming remote connection requests and ensure the proper application is launched to open the document, based on the remote application FTA executed on the client machine. Additionally or alternatively, the connection endpoint may prevent non-published file-type associations and their respective applications from being launched. 4) A web server may be configured to accept the published applications and FTAs, and package them up into an XML feed which is made available for download by authenticated clients.

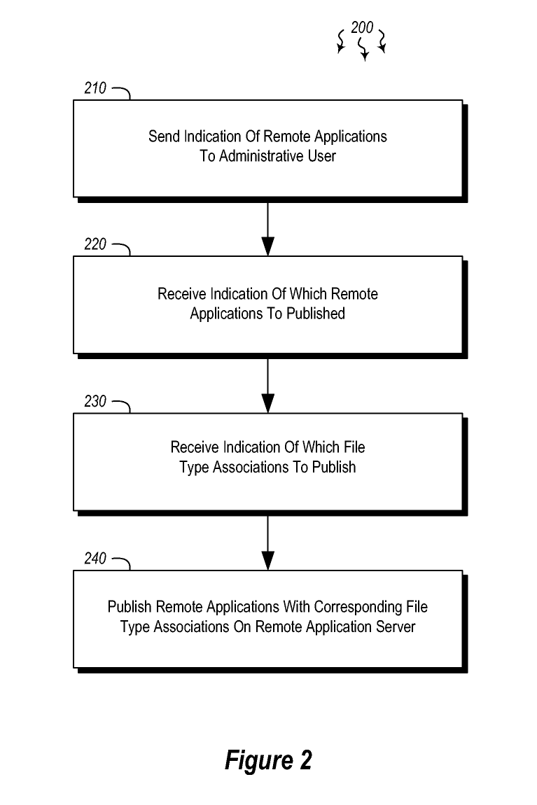

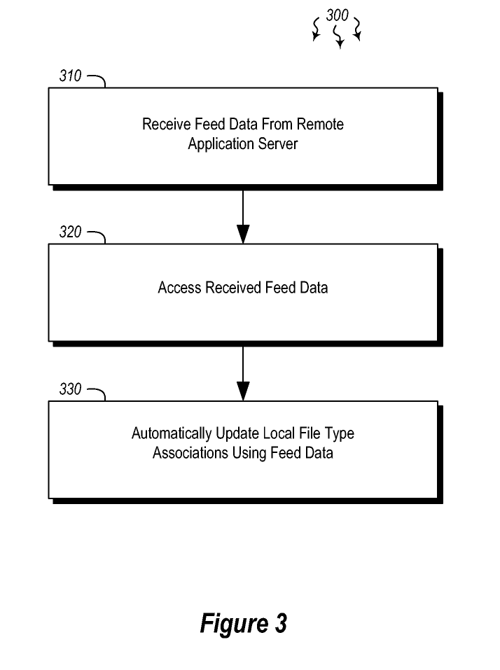

5) A client machine 106 which is the end-user's computer system. The client machine may be managed or unmanaged. As used herein, a managed client machine refers to a corporate computer system whose configuration is controlled by a corporate administrator. An unmanaged client machine, as used herein, refers to any computer system that is not centrally managed by an administrator (e.g. a personal home computer system). It includes a workspace downloader that downloads updated versions of the XML Feed, and installs the published remote applications and their file associations onto the client machine and installs remote application FTAs by installing them as per-user file type associations in the per-user registry. A remote desktop client on the client machine may be configured to accept a request to open a specific file via a remote application FTA. The remote desktop client then connects to the remote connection server, sending a) the network path to the document that should be opened, and b) the remote application that should be used to open it. These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for publishing file type associations for remote applications. The method 200 will now be described with frequent reference to the components and data of environment 100 of FIG. 1.

Method 200 includes an act of a remote application server sending to an administrative user an indication of remote applications that are provided by the remote application server (act 210). For example, remote application server 110 may send an indication 121 of remote applications made available by the remote application server. The remote applications may be any type of software application, function, “app” or other portion of executable software code. The remote application server itself may be a single computer system or may be a distributed system such as a server farm or a cloud computing system. Such distributed computing systems may distribute the applications in a variety of different manners including distributing certain applications to certain servers within the system, or distributing certain applications over multiple different servers. Thus, at least in some cases, two of the remote application servers provide different remote applications.

Method 200 further includes an act of receiving from the administrative user an indication of those remote applications that are to be published for computer systems managed by the administrative user (act 220). For example, remote application server 110 may receive indication 130 which includes those remote applications that are to be published for computers managed by administrative user 126. Thus, an administrative user (or “admin”) can specify for each of machines he or she controls which remote applications will be published. Those applications that are published are available to client subscribers 105 that are authenticated to the remote application server (perhaps via some type of authentication server).

The remote application server 110 also receives from the administrative computer system 125 of the administrative user 126 an indication of which file type associations 131 are to be published for the indicated remote applications (act 230). Thus, an admin may specify for each remote application provided by server 110, which file type or types that application is to open or otherwise operate on. For instance, the admin may specify that “Notepad” is to be used to open “.txt” files. Then, when a request is received from a client to open a .txt file, the remote Notepad application will be provided to the client to open the .txt file. The remote applications and any associated file types provided by the remote application server may be stored in a continually updated extensible markup language (XML) data file (a.k.a. feed data 123).

In some embodiments, the administrative user 126 may specify which remote applications are available on a per-user basis. The admin thus specifies which file types are associated with each of the user's associated remote applications (e.g. “.html” and “.xml” are to be opened with a web browser provided by the remote application server). Alternatively, the admin may specify which remote applications are available on a per-machine basis. Thus, in this case, the file type associations would apply for any user on that machine. An administrative UI may be provided on the administrative computer system 125 which allows the admin user 126 to manage the published remote applications 111 and corresponding file type associations 112 on the remote application server.

Method 200 also includes an act of publishing the indicated remote applications with the indicated file type associations on the remote application server, such that users accessing the remote application server have access to the published applications with the remote applications' associated file types (act 240). For example, application providing module 120 of the remote application server 110 may provide the appropriate remote application 122 with its corresponding file type association to the user 105. In this manner, authenticated users may access the remote application server and have access to a variety of remote applications.

In some embodiments, the remote application server may receive a request 107 from a client 105 to open a document using at least one of the provided remote applications 111. The remote application server may then determine which remote application is to be used for that specific type of document, based on the remote file type associations (specified by the admin user 126). Application providing module 120 may then provide the determined remote application to the client. In some cases, that client may subscribe to a remote application server feed 123 which automatically updates which remote applications and associated file types the user has access to.

In another embodiment, the remote application server may receive a request 107 from a client 105 to open a document using a remote applications that is different than the default file type association on the remote application server. The remote application server may override the default file type association on the remote application server with the remote application requested by the client. Then, application providing module 120 may provide the client-requested remote application to the client.

In yet another embodiment, the remote application server 110 may receive a request 107 from a client 105 to open a document using a remote applications that is different than the default file type association on the remote application server. The remote application server may determine that the client-requested application is no longer available (e.g. when the XML data file is updated to show that one or more previously provided applications are no longer published by the remote application server) and either indicate that an error has occurred and the user is to choose a local application, or prompt the client to select a different remote application from the remote applications published by the remote application server. The application selecting module 115 may receive a remote application selection from the client, select the user-specified application and pass the selection to the application providing module 120 to provide that application to the client.

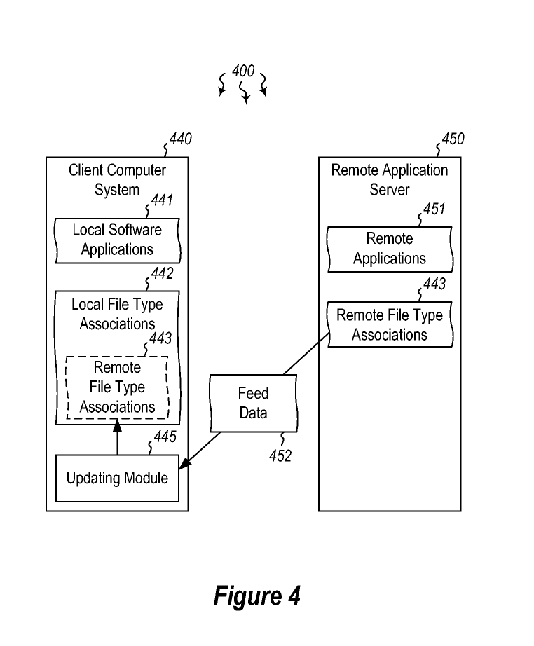

FIG. 3 illustrates a flowchart of a method 300 for automatically updating file type associations for remote applications. The method 300 will now be described with frequent reference to the components and data of environments 100 of FIG. 1 and 400 of FIG. 4.

Method 300 includes an act of receiving feed data from a remote application server at a local client computer system, the local client computer system including one or more local file type associations for one or more locally installed software applications (act 310). For example, client computer system 440 may receive feed data 452 from remote application server 450 (which may be similar to or the same as remote application server 110 of FIG. 1). The client computer system already includes local file type associations (FTAs) 442 for its locally installed software applications 441. The local computer system then accesses the received feed data 452. The feed data indicates which remote applications 451 are provided by the remote application server and further provides file type associations 443 for each of the remote applications 451 provided by the remote application server (act 320). Thus, after receiving the feed data, the client computer system is aware of those remote applications provided by server 450.

Updating module 445 of the client computer system then automatically updates the local FTAs 442 with the received FTAs 443 for the remote software applications 451 to include the remote FTAs 443 alongside the local FTAs 441 (act 330). Thus, at least in some cases, the client computer system's FTAs include at least one local application and at least one remote application. Local icons may be created for those applications provided by the remote application server. In some cases, icons can be provided not only for the application, but also for the documents that have file associations with the applications (e.g. a particular word processing application may have one icon, while document files associated with that application may have a similar (but not identical) icon).

The client computer system may then send an indication to the remote application server 450 that a data file is to be accessed using a remote application. The client system receives an indication from the remote application server indicating which remote applications are available to open the data file and allows the user to select one of the available remote applications to open the data file. In some cases, the local computer system sends both a network path 108 of the data file that is to be opened as well as an indication of which remote application is to be used to open the data file (FTA 109). The user's selected file type associations may, at least in some cases, be prioritized over file type associations on the remote application server (as set by the administrative user).

Accordingly, the system described above provides flexibility in allowing an administrator to publish certain remote applications with certain specified FTAs for each application, and provides flexibility in allowing the client to choose local and remote FTAs (and, in some cases, allows these client-selected choices to override the administrator's choices). This choice of local or remote FTAs may be particularly useful when the user is in a place with no internet connectivity and remote applications are not available. In such cases, the user can simply choose to use local FTAs. Still further, at least in some cases, these FTAs may be specified on a per-user or a per-machine basis.

One final embodiment will be described that illustrates an example data flow. The data flow includes the following steps: 1) At the request of the administrative user (via an administrative UI), a settings reader on the remote application server reads in from the system registry the list of per-machine FTAs for a set of applications. 2) The list of per-machine FTAs is sent to the administrator UI, which then displays them to the administrator to choose which should be published. 3) After the administrator has made his or her choice, the list of published remote applications and corresponding FTAs are sent to both a web server and a publishing endpoint. 4) The publishing endpoint on the remote connection server writes the list of published applications and FTAs to a publishing storage. 5) The web server serializes the list of published applications and FTAs into an XML feed, which is eventually downloaded on the client machine.

6) The client machine parses the XML file, installs any corresponding files and icons to the local file system, incorporates the published remote applications into the user's user interface and installs the remote application FTAs as per-user FTAs by writing changes to the per-user registry. 7) The client machine picks up the newly installed remote applications and file type associations and updates its UI to reflect the availability of those remote applications. The updated local UI includes the remote applications in the user's operating system UI, icons for associated file types, and an “Open With” list option for associated file types. 8) The user triggers a remote application FTA (typically by double-clicking a file whose type is associated with a remote application). The client machine operating system, acting upon the installed remote application FTA, opens a remote desktop client. The remote desktop client is given: a) the path to the document that should be opened, b) the remote application file that should be used to make the connection, and c) the remote application FTA that triggered the launch.

9) The remote desktop client converts the local path to the document that should be opened into a network path, and using the remote application file, makes a remote connection to the connection endpoint on the remote application server. 10) The connection endpoint receives the network path to the document that should be opened, and an identifier for the remote application that should be used to open the document. It checks this information against the published FTAs in the publishing storage to ensure this is actually a valid request based upon what the administrator has published, and, if it is, causes the application to open the document in the remote session. If the request is not valid, an error is sent to the client.

In an alternate embodiment, the information about which remote application is to be used to open the document is not sent to the connection endpoint in Step 9; rather, only the network path to the document to be opened is sent. In this embodiment, Step 10 is replaced by the following: 10A) The connection endpoint receives the network path to the document that should be opened. It requests the per-machine primary handler FTA for that document's file type from the operating system of the local computer system. 10B) The connection endpoint then checks if the per-machine primary handler application retrieved in Step 10 is on the list of published applications, by checking against the list stored in the publishing storage. If the application is in the list, it is used to open the document in the remote session. If it is not, an error is sent to the client.

Accordingly, methods, systems and computer program products are provided which publish file type associations for remote applications according to the above description. Moreover, methods, systems and computer program products are provided which automatically update file type associations for remote applications as described above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a remote application server including at least one processor and a memory, in a computer networking environment including a plurality of computing systems, a computer-implemented method for publishing file type associations for remote applications, the method comprising:
an act of a remote application server sending to an administrative user an indication of remote applications that are provided by the remote application server;
an act of receiving from the administrative user an indication of those remote applications that are to be published for computer systems managed by the administrative user;
an act of receiving from the administrative user an indication of which file type associations are to be published for the indicated remote applications; and
an act of publishing the indicated remote applications with the indicated file type associations on the remote application server, such that users accessing the remote application server have access to the published applications with the remote applications' associated file types.

2. The method of claim 1, further comprising:
an act of receiving at the remote application server a request from a client to open a document using at least one of the provided remote applications;
an act of determining which remote application is to be used for that type of document, based on the remote file type associations; and
an act of providing the determined remote application to the client.

3. The method of claim 1, wherein the remote application server blocks non-published file-type associations from being used by the computer system.

4. The method of claim 3, wherein the administrative user specifies which file types are associated with each of the user's associated remote applications.

5. The method of claim 1, wherein the administrative user specifies which remote applications are available on at least one of a per-user basis and a per-machine basis.

6. The method of claim 2, wherein the client subscribes to a remote application server feed which automatically updates which remote applications and associated file types the user has access to.

7. The method of claim 2, further comprising:
an act of receiving at the remote application server a request from a client to open a document using a remote applications that is different than the default file type association on the remote application server;
an act of overriding the default file type association on the remote application server with the remote application requested by the client; and
an act of providing the client-requested remote application to the client.

8. The method of claim 1, wherein the remote applications and associated file types provided by the remote application server are stored in a continually updated extensible markup language (XML) data file.

9. The method of claim 8, further comprising:
an act of receiving at the remote application server a request from a client to open a document using a remote applications that is different than the default file type association on the remote application server;
an act of determining that the client-requested application is no longer available;
an act of prompting the client to select a different remote application from the remote applications published by the remote application server;
an act of receiving a remote application selection from the client; and
an act of providing the client-selected remote application to the client.

10. The method of claim 9, further comprising updating the XML data file to show that client-requested application is no longer published by the remote application server.

11. The method of claim 1, wherein the remote application server is part of a server farm which includes a plurality of different remote application servers.

12. The method of claim 11, wherein at least two of the remote application servers provide different remote applications.

13. The method of claim 12, wherein the administrative user selects which remote application is to be used to open a given file type across the remote application servers in the server farm.

14. A computer program product for implementing a method for automatically updating file type associations for remote applications, the computer program product comprising one or more computer-readable storage media having stored thereon computer-executable instructions that, when executed by one or more processors of the computing system, cause the computing system to perform the method, the method comprising:
an act of receiving feed data from a remote application server at a local client computer system, the local client computer system including one or more local file type associations for one or more locally installed software applications;
an act of accessing the received feed data, the feed data indicating which remote applications are provided by the remote application server and further indicating one or more file type associations for each of the remote applications provided by a remote application server; and
an act of automatically updating the local file type associations with the received file type associations for the remote software applications such that the client computer system's file type associations include at least one local application and at least one remote application.

15. The computer program product of claim 14, further comprising:
an act of sending an indication to a remote application server that a data file is to be accessed using a remote application;
an act of receiving an indication from the remote application server indicating which remote applications are available to open the data file; and
an act of selecting one of the available remote applications to open the data file.

16. The computer program product of claim 14, further comprising an act of creating one or more icons for those applications provided by the remote application server.

17. The computer program product of claim 14, wherein the user's selected file type associations are prioritized over file type associations on the remote application server.

18. The computer program product of claim 14, wherein the local computer system sends both a network path to the data file that is to be opened and an indication of which remote application is to be used to open the data file.

19. A computer system comprising the following:
one or more processors;
system memory;
one or more computer-readable storage media having stored thereon computer-executable instructions that, when executed by the one or more processors, causes the computing system to perform a method for publishing file type associations for remote applications, the method comprising the following:
an act of a remote application server sending to an administrative user an indication of remote applications that are provided by the remote application server;
an act of receiving from the administrative user an indication of those remote applications that are to be published for computer systems managed by the administrative user;
an act of receiving from the administrative user an indication of which file type associations are to be published for the indicated remote applications;
an act of publishing the indicated remote applications with the indicated file type associations on the remote application server, such that users accessing the remote application server have access to the published applications with the remote applications' associated file types;
an act of receiving at the remote application server a request from a client to open a document using at least one of the provided remote applications;
an act of determining which remote application is to be used for that type of document, based on the remote file type associations; and
an act of providing the determined remote application to the client.

20. The computer system of claim 19, wherein an administrative user interface is provided which allows the administrative user to manage the remote applications and corresponding file type associations on the remote application server.
